(19) United States
(12) Patent Application Publication
(10) Pub. No.: US 2007/0074050 A1
(43) Pub. Date: Mar. 29, 2007

(54) System and method for software and data copy protection

(76) Inventor: Noam Camiel, Tel-Aviv (IL)

Correspondence Address: NOAM CAMIEL, APT 4, 47 BILV ST., TEL-AVIV, 64256, IL

(21) Appl. No.: 11/518,923

(22) Filed: Sep. 12, 2006

Related U.S. Application Data
(60) Provisional application No. 60/716,557, filed on Sep. 14, 2005.

(51) Int. Cl. G06F 12/14

(52) U.S. Cl. 713/193

(57) ABSTRACT

A system and method is introduced to prevent unauthorized copying, unauthorized usage and altering of data and software. An autonomous storage device such as a USB flash drive contains protected data and code necessary for software running on a digital appliance to properly function. Software that executes in a digital appliance such as a computer can send requests to programs residing on the attached storage device. The protected programs within the storage device execute within storage device internal program interpreter. Software that executes in digital appliance receives results from execution of protected programs in storage device and only then can complete its tasks. Protected software and content files can be dynamically downloaded and added securely to storage device. Protected software and content files are not accessible by digital appliance. Software on digital appliance may be used when storage device is attached to digital appliance. No requirement for network connection is required once software is installed.

### CROSS-REFERENCE TO RELATED APPLICATIONS

This application uses the frammis vane disclosed in provisional patent application U.S. 60/658,568 “System and Method For A Dynamic Policies Enforced File System For A Data Storage Device” filed Mar. 7, 2005 by the present inventor. This application claims the benefit of U.S. Provisional Patent Ser. No. 60/716,557, filed Sep. 14, 2005 by the present inventor.

### FIELD OF INVENTION

This invention generally relates to the protection of data and software from unauthorized usage and copying, and more particularly but not exclusively to distributing and protecting data and software to be used only according to set policies.

### BACKGROUND OF THE INVENTION

Computer software today is being protected by different means in order to prevent its illegal use and copying. Some of these protection mechanisms include copy protection mechanisms built into the software. Others include user verification. Nevertheless, hackers manage to bypass these protection schemes. These hacked versions are then made available, for example on the Internet for free download.

Hackers are able to break program protection due to the fact that hackers have access to entire memory, CPU and registers of their computer. With advanced tools, reengineering of protecting methods is conducted to create a version that can be freely distributed and used.

Some copy protection mechanisms operate by requiring the user to be online on the Internet while using the program. In this scenario, the software installed on the user's computer is incomplete and some portions are carried out online. The problem with this mechanism is that network connection is not always available and can be a major drawback for people wishing to use the software when not connected to the Internet, for example, people on the move. Another major disadvantage of the online protection mechanism is that enterprises that are very carefully about protecting their data and network do not wish their software to transfer data outside the organization.

Some software companies wish to offer a demonstration version of their program, for people to evaluate prior to their purchase. The problem with these versions is that hackers can use these demonstration versions to break the software protection mechanisms. As a result, the software vendors cripple these demonstration versions. This is done in order to prevent hackers from using these software versions to break their software and spread it for free.

Other problems in the field of software protection include protecting databases from being used not as directed by its owner. For example, suppose a phone directory program is sold to individuals. A hacker can then use the hone directory database in unlawful manners, such as lookup personal information from a phone number, or request the personal information of all people living in a building or in a certain street.

Further problems, related to the above include protecting programs from being altered by hackers. An altered program can result in changing policies of software rules by hackers. Yet other problems include protecting the execution environment of the program. If the execution environment of a program can be altered by a hacker, security measures built into a program can be circumvented and the program be used in manners undesired by program maker. This can result in using protected data in ways not allowed by data owner.

The protection of data content files such as database files as described above, as well as other data content files is a part of this problem of protecting content from being copied and used in manners not as intended.

There is thus a widely recognized need for way to protect software and data that would prevent software copying, database access, protecting program execution environment and protecting programs from being altered and it would be highly advantageous to have such a method devoid of the above limitations.

### SUMMARY OF THE INVENTION

According to one aspect of the present invention there is provided an autonomous data storage device coupled to an external device, the autonomous data storage device comprising:
a physical file storage;
an internal file management unit capable of accessing said physical file storage and capable of blocking access to at least part of said physical file storage from said external device;
an internal program interpreter unit for executing programs located in said physical file storage;
whereby external software executing in said external device requests said autonomous data storage device to execute protected internal software located in said physical file storage, said protected internal software is at least partially blocked from said external device access by said internal file management unit, said internal program interpreter executes said protected internal software and sends results to said external device for said external software execution in said external device.

According to a second aspect of the present invention there is provided a method for executing a digital appliance program in a protected manner using an autonomous data storage device coupled to a digital appliance the method comprising:

(a) creating at least one protected program to be executed separately from said digital appliance program,

(b) requesting said autonomous data storage device to execute at least one of said protected programs for said digital appliance program,

(c) executing at least one of said protected programs by an internal program interpreter located inside said autonomous data storage device,

(d) sending calculated results of said execution of at least one protected program to said digital appliance program.

According to a third aspect of the present invention there is provided a method for preparing and distributing protected programs to be executed on a storage device in conjunction with digital appliance programs running on a digital appliance, the method comprising:

(a) creating at least one said protected program to be executed in conjunction as part of said digital appliance program,

(b) forming license information for said at least one protected program for at least one requesting storage device,

(c) distributing said at least one protected program and said license information securely to said requesting at least one storage device.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram illustration of a program split into a main program, a secondary program and a data file, in accordance with an embodiment of the present invention;

FIG. 2A is a block diagram illustration of a media device capable of executing a computer program securely, connected to a digital appliance in accordance with an embodiment of the present invention;

FIG. 2B is a detailed block diagram illustration of a media device capable of executing a computer program securely, connected to a digital appliance in accordance with an embodiment of the present invention;

FIG. 3 is a schematic flowchart for executing a computer program on a computer in a secure manner using a secure media device, in accordance with an embodiment of the present invention;

FIG. 4 is a schematic flowchart for the preparation and distribution of software for use with a secure media device, in accordance with an embodiment of the present invention

FIG. 5 is a block diagram illustration of a media device connected to a digital appliance, in accordance with an embodiment of the present invention.

FIG. 6 is a block diagram illustration of non-volatile media of a media device, in accordance with an embodiment of the present invention.

FIG. 7 is a block diagram illustration of an exemplary system in accordance with an embodiment of the present invention.

It will be appreciated that, for simplicity and clarity of illustration, elements shown in the figures have not necessarily been drawn to scale. For example, the dimensions of some of the elements may be exaggerated relative to other elements for clarity. Furthermore, where considered appropriate, reference numerals may be repeated among the figures to indicate corresponding or analogous elements.

### DESCRIPTION OF THE PREFERRED EMBODIMENTS

The preferred embodiments teach an autonomous data storage device for protecting software files and data files stored on it. Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present invention includes several embodiments that can be realized using the autonomous data storage device described herein. In this disclosure, an autonomous data storage device for storing data files via an external file interface is described, where the external file interface is controllable from an external device such as a computer to which it is connected via a data link such as a USB. The autonomous data storage device further comprises a physical file storage such as flash memory, and an internal file management system. The internal file management system can block the access of external device to files contained within physical file storage. The autonomous data storage device further comprises an internal program interpreter unit such as a Java Virtual Machine, which is capable of carrying out programs within autonomous data storage device. The internal program interpreter unit can dynamically access code and data files within internal management file system that are blocked for access to external device. The autonomous data storage device can therefore execute protected software in a secure computing environment within autonomous data storage device. Software execution results, optionally making use of protected data files within the autonomous data storage device, can then be sent to external device without revealing the content of the protected code and optional data files.

Software that executes in digital appliance, such as a computer, can send requests to programs residing on media device, which are inaccessible directly to the digital appliance. These programs within media device execute within media device internal program interpreter. Software on digital appliance receives results from execution of such inaccessible program and only then can complete its tasks.

Executing software in this manner together, both software piece on digital appliance and protected software piece on media device, forms one entity of protected software execution. Executing software in this manner allows protecting the entire software from being duplicated; executing software according to set policies; allowing usage of content files according to set policies; executing software in a manner that software code and data cannot be altered; executing software in a protected environment; allowing program and content downloading without compromising data content; allowing usage of protected software and data content even when there is no network connection.

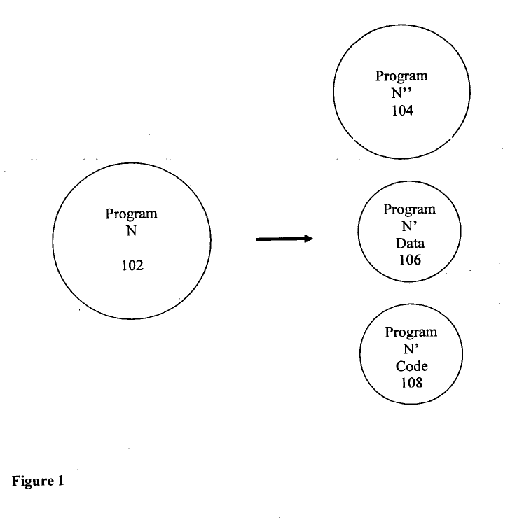

Reference is now made to FIG. 1, which is a block diagram illustration of a program split into a main program, a secondary program and a data file, in accordance with an embodiment of the present invention comprising initial program N 102 and a result set of files, program N″ 104, program N′ data file 106 and program N′ code file 108. Program N″ 104 is a main program intended to execute on a digital appliance such as a PC, which may be prone to attacks from hackers. Program N″ 104 is lacking information or one or more algorithms necessary to function like program N. The information lacking is included in the program N′ data file 106 and/or program N′ code file 108. Program N′ code file 108 is made in a way so that execution of program code N′ 108 with possible requested parameters from program N″ 104 will be identical to execution of program N 102. Program code file 108 can access program N′ data file 106 during its execution.

The separation of program N into program N″, program N′ code and additional N′ data file is specific to each program. This separation may be done in a manner so that the N′ code file and N′ data file are a crucial part of program N or contain an important aspect of program N. Code File N′ 108 and data file N′ 106 may be handled and kept in a manner that is safe, for example from being duplicated or altered. This is explained further in this document.

As an example of splitting a program, suppose that program N is a word processor program having a spell-checking feature. Program N″ may be the word processor program without the spell checking feature enabled. The spell checking feature is packaged as a program file N′ code 108 that can search in a dictionary to find the existence of a certain word within a dictionary, or to find closely related words if the exact word is not found. In this example the program N′ data file 106 includes a dictionary of the English language to be used with program N′ code 108. If a user copies the word processing file, program N″, then this user will not be able to execute spell checking with that word processor because this requires data code N′ 108 and data file N′ 106. This example illustrates the difficulty of reverse engineering N′ code 108 and N′ data file 106, since even if many documents are checked for spelling, not all words in the English language will be revealed and the algorithm for suggesting related words is not revealed. In a similar manner, other programs can be split to allow protecting algorithms and data files, hence allowing to protect original program N 102.

Another example of splitting a program, can include content data files such as audio files, files containing book information, video information etc, which may be used as N′ data file 106. Data files can be added or removed. This invention does not limit program N 102 to be a static single program. In this case program N′ code 108 may be a full or partial content playing or rendering mechanism, a streaming mechanism etc.

In some embodiments program N′ code 108 is made in a manner so that its execution requires relatively low CPU and a small volatile memory footprint to be executed in a limited resources environment.

In the description herein below, the term Media Device refers a digital storage unit such as a computer hard disk, a flash card or a key-ring storage device etc.

In the description herein below, the term Digital Appliance refers to a digital appliance making use of a media device, such as a computer, a multimedia player, a mobile phone etc.

In the description herein below, the term Patent A refers to provisional patent application U.S. 60/658,568 filed Mar. 7, 2005 by the present inventor. Patent A describes how some files on media device may become inaccessible to digital appliance, but still accessible within media device so that media device may use these files to output data back to digital appliance.

In the description herein below, the term Script Interpreter refers to a program that takes a file as input and executes it directly without needing to compile the input file first. Some examples of script interpreters are C-shell, Perl, Bourne Shell etc.

In the description herein below, the term “Script File” refers to a file that is executed by a script interpreter. Some examples are C-Shell scripts; Perl scripts; Bourne shell scripts etc.

In the description herein below the term Java Virtual Machine or JVM refers to an abstract computing machine whose instruction set is called Java bytecode, where Java is a computer programming language.

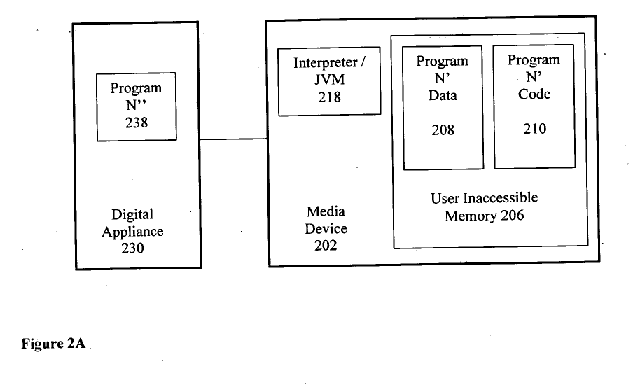

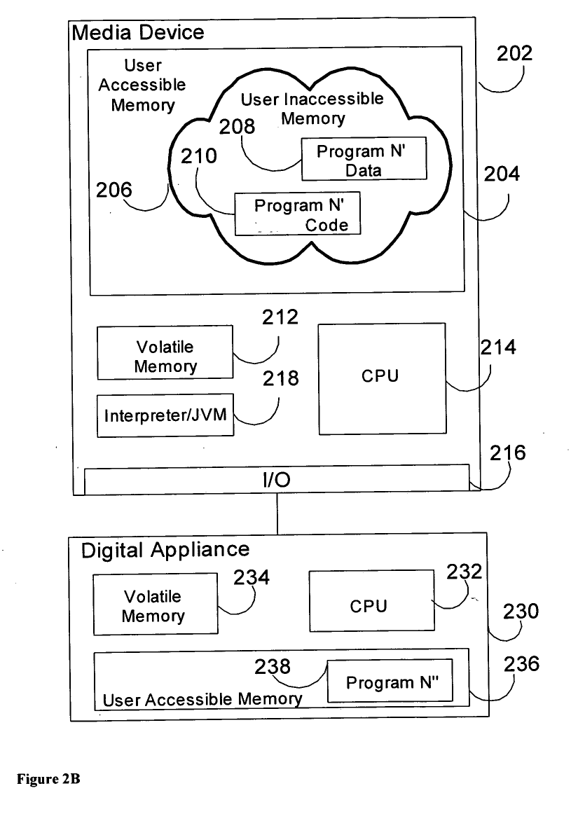

Reference is now made to FIG. 2A, which is a block diagram illustration of a media device capable of executing a computer program securely, connected to a digital appliance in accordance with an embodiment of the present invention comprising a media device 202 connected to a digital appliance 230. Media device 202 includes an internal program interpreter unit which may comprise a script language interpreter or a Java Virtual Machine (JVM) 218 capable of executing file scripts or Java bytecode files. The execution of the internal program interpreter unit 218 occurs within media device unreachable by digital appliance 230. The media device 202 includes non-volatile memory inaccessible to digital appliance 206 but accessible to internal program interpreter unit 218. Files inaccessible to digital appliance include data file for program N′ 208 and program code for program N′ 210. Program code 210 may be a script code or Java code. The files 208 and 210 are inaccessible to the digital appliance 230. Digital appliance 230 includes an installed program, program N″ 238.

The program N′ data file 208 and program N′ code 210 are as described in FIG. 1, program N′ data file 106 and program N′ code 108 while program N″ 238 is as described in FIG. 1, program N″ 104.

Program N″ 238 can now execute code portions that require N′ code 210 and data 208 files, by making a request to media device. Media device can then execute program N′ code using internal program interpreter unit 218, optionally using program N′ data 208 to output data back to program N″ 238 executing in digital appliance. In embodiments where media device is able to protect its execution environment and program N′ code 210 and data 208 are inaccessible to media device, an environment for controlled, secure, unalterable computing is achieved.

Reference is now made to FIG. 2B, which is a detailed block diagram illustration of a media device capable of executing a computer program securely, connected to a digital appliance in accordance with an embodiment of the present invention comprising a media device 202 connected to a digital appliance 230. FIG. 2B is similar in many ways to FIG. 2A and is more detailed. Media device 202 includes volatile memory 212, and internal independent CPU 214 inaccessible by digital appliance 230 for internal media device computations. Media device 202 includes an I/O interface unit 216 to interface with digital appliance 230. Media device 202 includes an internal program language interpreter such as a Java virtual machine 218 capable of executing interpreted programs such as computer program scripts and Java bytecode files. The execution of the internal program interpreter 218 occurs by media device CPU 214 which is unreachable by digital appliance 230. The media device 202 includes non-volatile memory 204. The non-volatile memory may be used to store user files. Some files within non-volatile memory 204 may become inaccessible to digital appliance. Such a method is explained in patent A. Files that are inaccessible to digital appliance 206 are accessible to media device CPU 214. Files inaccessible to digital appliance include program N′ data file 208 and program N′ code file 210. Digital appliance 230 includes CPU 232, volatile memory 234, non-volatile memory 236 and installed program N″ 238 in non-volatile memory 236.

The program N′ data file 208 and program N′ code 210 are as described in FIG. 1, program N′ data file 106 and program N′ code 108. These files are made in such a manner so that they include some specific functionality of original program. Program N″ 238 is as described in FIG. 1, program N″ 104, which is the program lacking the functionality of program N′ code and data files.

Program N″ 238 can now execute code portions that require N′ code 210 and data 208 files, by making a request to media device. Media device can then execute program N′ code using internal interpreter/JVM 218, optionally using program N′ data 208 to output data back to program N″ 238 executing in digital appliance. In embodiments where media device is able to protect its execution environment and program N′ code 210 and data 208 are inaccessible to media device, an environment for controlled, secure, unalterable computing is achieved.

This image illustrates in a more detailed way to FIG. 2A a manner of executing a computer program securely, by executing a portion of the program in an environment unreachable by digital appliance.

Patent A explains how files such as program N′ data 208 and program N′ code 210 may be transferred securely into user media device through the network without revealing data contents to the digital appliance. Patent A also explains how several different policies may be used within a single media device so that several programs may execute through the same device unit without allowing one program data files to be accessible to another program script/Java file. Using patent A, these properties can be used in this present invention. Code and data files may be transferred securely through the network to add and enhance functionality of media device. In addition, several entities such as companies may produce different code portions, which cannot access other entities code or data files.

In some embodiments, other manners than using patent A for protecting files from digital appliance access may be used. Such manners may include hiding all non-volatile memory from digital appliance; hiding a portion of non-volatile memory from digital appliance; In some embodiments file encryption methods may be used such that hidden files are encrypted and keys are known internal to the media device. Internal interpreter/JVM 218 may use internal keys to make use of encrypted files securely. In other embodiments other manners may be used to achieve this goal.

The internal language interpreter/JVM is capable of executing code files such as program N′ code 210. This execution occurs on media device CPU 214 unreachable by digital appliance 230.

In some embodiments a script language interpreter may be used to execute file scripts. In some embodiments a Java virtual machine such as a micro edition JVM or a specific tailored JVM may be used to execute Java bytecode programs. In some embodiments a dialect of Java may be used. In this preferred embodiment, program N′ code 210 is a Java bytecode program. In some embodiments other types of interpreted languages may be used.

In some embodiments program N′ code 210 may make changes within program N′ data file 208.

FIGS. 2A and 2B illustrates a manner of executing a computer program securely, by executing a portion of the program in an environment unreachable by digital appliance. The splitting up of a program into secure code and optional data file is described in FIG. 1. The protected computer program code may make use of one or more protected data files unreachable by external digital appliance. In this manner, code and data files may be used by a digital appliance in a secure manner, such that secure code data files cannot be altered or copied, and executing environment of the secure code and data is protected from access of digital appliance. Computed results of protected software and data files may be sent out to digital appliance. This allows protecting software and data components from uncontrolled access even during the execution of the program. The fact that execution of internal code is carried out using an internal interpreter rather than compiled code, means that software portions may be developed and sent to the device dynamically, allowing the device to serve as a dynamic platform for protected software and data. New protected programs and/or data files may be sent securely into media device to enhance and increase its functionality dynamically.

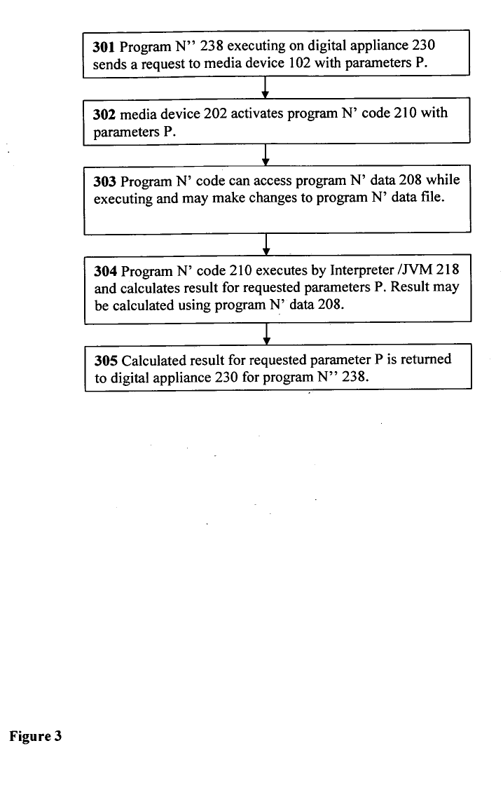

Reference is now made to FIG. 3, which is a schematic flowchart for executing a computer program on a computer in a secure manner using a secure media device, in accordance with an embodiment of the present invention

In step 301 program N″ 238 executes within digital appliance 230 running on CPU 232 and volatile memory 234 of digital appliance. Program N″ sends a requests to media device 202 with parameters P. The request is made through media device I/O unit 216.

In step 302 media device 202 activates the execution of program N′ code 210 with input parameters P. The code is executed by internal interpreter 218, running on CPU 214 and volatile memory 212 within media device 202.

In step 303, program N′ code can access program N′ data file 208 while executing. Program N′ code may make changes to program N′ data file. Other data files may change during program N′ data file execution. These files may be accessible or may become accessible to digital appliance at a later time.

In step 304, program N′ code 210 executes and calculates result for requested parameters P. Result may be calculated with data included in program N′ data file 208.

In step 305, calculated result for requested parameters P is returned to digital appliance 230. Results may be returned to digital appliance in various ways, such as through USB response messages; though files being written by executing program N′ within media device for digital appliance etc.

This series of steps displays how program N″ uses secure code and data files located on media device while executing. Without the media device, program N″ misses some capabilities or may be totally useless. The code 210 and data 208 files cannot be accessed by digital appliance directly and therefore cannot be duplicated. Protected code file and data file may be prepared so that it would be very difficult to imitate its actions or would take a long time to crack. For example, if sending all possible result values for all input parameters P from program N″ would take sufficiently long enough time then this protection prevents program N from being duplicated.

Some hacking attempts that may take place by hackers are (a) brute force attempts to get all return values for all input parameters and (b) attempt to use a single media device for several running instances of the software. (perhaps through the network).

A prevention measure against hackers is to check the number of requests made within a period of time, as compared with a normal program request values. If the request rate from a media device is much higher to the normal request rate, device usage may be suspended temporarily or indefinitely.

Another prevention measure against hackers is to internally follow the state of which the software runs, by following the types of requests received from digital appliance. A media device may be locked in case illegal transition between states occurs.

In some embodiments data may be communicated securely between media device and digital appliance. A digital appliance may be a trusted server such as described in patent A. In such a case, certificate extension or other data changes that may represent electronic money, for example, may take place within media device.

In some embodiments data may be communicated securely between media device and a trusted server. This communication is made through a connection between a trusted server and digital appliance using encryption. Such communication is described in patent A. In such a case, certificate extension or other data changes that may represent electronic money, for example, may be changed within media device. This secure communication may require network connection.

In the description herein below, the term “certificate” refers to a file that includes information specifying usage policies for a file or for a group of files. For example, the certificate may hold an expiration date for the usage of the files, or the certificate may hold a number of times a program may execute.

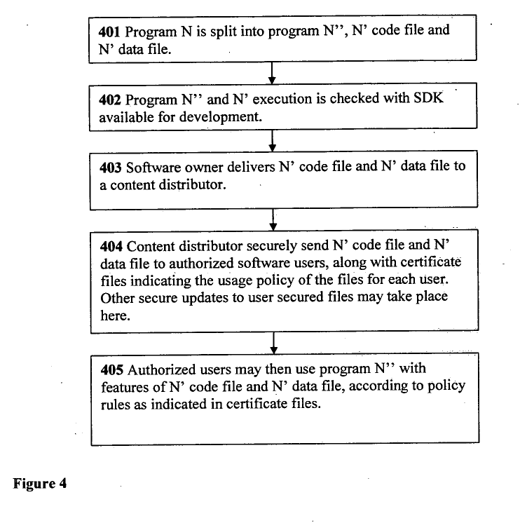

Reference is now made to FIG. 4, which is a schematic flowchart for the preparation and distribution of software for use with a secure media device, in accordance with an embodiment of the present invention

In step 401 Program N is split into program N″, N′ code file and N′ data file as explained in FIG. 1.

In step 402 Program N″ and N′ execution is checked and debugged with SDK (Software development kit) that may be available for development. With this tool it is possible to develop and check N′ code file and N′ data file prior to shipment of software and data to software users.

In step 403 software owner delivers developed N′ code file and N′ data file to a content distributor. A content distributor is able to send files securely into user's media device, such as explained by patent A.

In step 404, a content distributor securely send N′ code file and N′ data file to authorized software users, along with certificate files indicating the usage policy of the files for each user. This occurs such as explained in patent A. Other secure updates to user secured files may take place here as well.

In step 405 authorized users may then use program N″ with features of N′ code file and N′ data file, according to policy rules as indicated in certificate files. Usage of software may be made without network connection.

This series of steps displays how program N may be sent through the network for example, to users that can use program N fully but cannot duplicate program N. In addition, it is possible, per user, to allow usage of software for a specific amount of time for demonstration purposes or for leasing software for a limited period of time etc. With the present invention it may be possible to add software to media device after the device is sold to a user, without requiring firmware update for example.

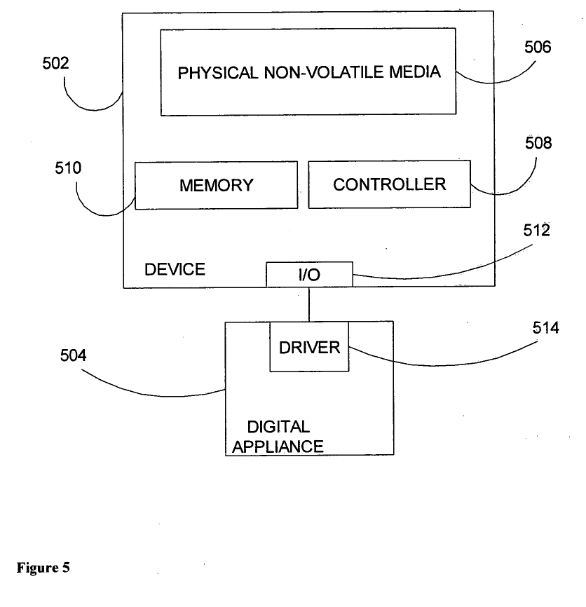

Reference is now made to FIG. 5, which is a block diagram illustration of a media device connected to a digital appliance, in accordance with an embodiment of the present invention comprising a media device 502 connected to a digital appliance 504. The media device 502 includes a physical non-volatile media 506, a controller 508, memory 510 and I/O module 512. The digital appliance 504 includes a driver 514 for communicating with media device 502. The block diagram of FIG. 5 presents some of the parts making up the media device 502, showing the device with computational capability separate from the digital appliance allowing for the capability of enforcing security policies for files as well as carrying out computations internal to the media device separate from the digital appliance. The controller 508 making computations internal to the media device is capable of using files, which may be available internally to the media device and not to the digital appliance. As a result of media device 502 computations and internal policies, the controller 508 can generate files and/or data with or without permission for the digital appliance to read. The physical non-volatile media 506 may includes user accessible files as well as media used only internally by the device.

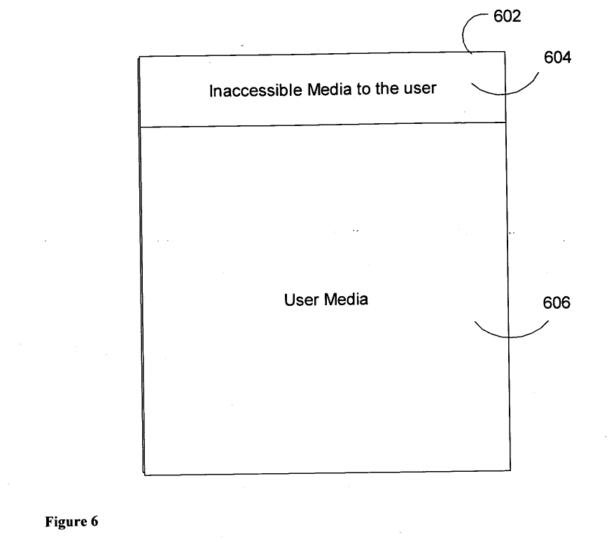

Reference is now made to FIG. 6, which is a block diagram illustration of non-volatile media of a media device, in accordance with an embodiment of the present invention comprising a media device non-volatile memory 602, which includes media inaccessible to the user 604 and user accessible media 606. The inaccessible media is available internally to the media device and not to the digital appliance

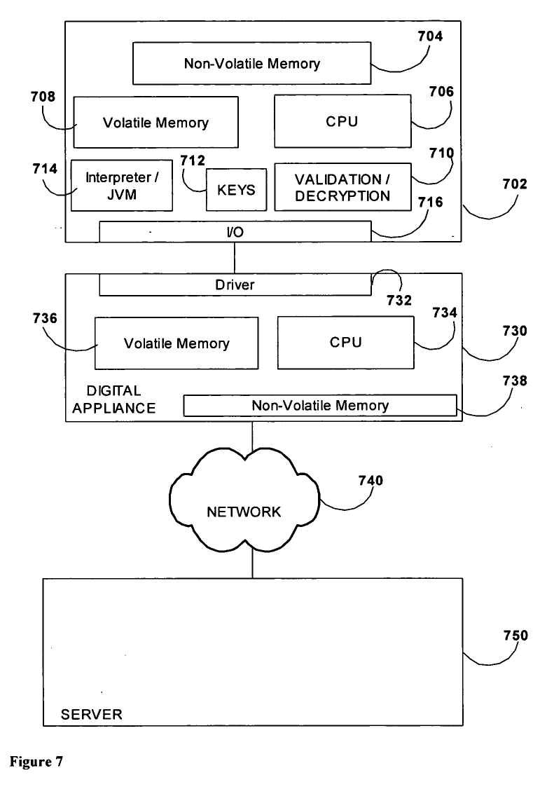

Reference is now made to FIG. 7, which is a block diagram illustration of an exemplary system in accordance with an embodiment of the present invention comprising a media device 702 connected to a digital appliance 730. The digital appliance 730 is connected to a server 750 through a network 740. The media device 702 includes a non-volatile memory 704, a CPU 706, volatile memory 708, a validation/decryption unit 710, keys 712, an internal program interpreter/Java virtual machine 714 and an I/O module 716. The digital appliance 730 includes a driver 732 to communicate with the media device 702. The digital appliance 730 includes a CPU 734, volatile memory 736, and non-volatile memory 738. The non-volatile memory 704 of media device 702 refers to media that may be accessed and used by the digital appliance 730, as well as some files that are not accessible to digital appliance, as described in FIGS. 2A, 2B, 6 etc. The validation/decryption unit 710 allows data validation and or decryption possibly with an internal decryption key 712, for the purpose of authorizing data from the network. The digital appliance 730 is connected to a server 750 through the Network 740. The system in this figure allows downloading files from the server 750 into the media device 702 so that the file is accessible to the digital appliance 730 in an encrypted form, but media device 702 may decrypt the file using internal keys and validation/decryption unit. Transferring files in this manner is further explained for example in Patent A. Files that are transferred from the server to the media device may be data files as well as files including code for the internal program interpreter/Java virtual machine to execute. The CPU 706 of media device 702 as well as internal program interpreter/Java virtual machine 714 may access files not available for digital appliance, in order to process and output data. Input data and parameters may be accepted by media device 702 from digital appliance 730 through I/O module 716 to be used for processing by media device. Processing of data by media device may be done with the following modules: internal CPU 706, internal program interpreter 714, inaccessible data and code files to digital appliance, input data from digital device as well as any additional means which may be contained within media device 702. The processed output data of media device may be for example placed into an accessible file of media device 702 for digital appliance 730 use.

The system of FIG. 7 has the ability to transfer restricted files into the media device without user of digital appliance being able to access their contents, as described in FIG. 4; In addition the system of FIG. 7 has the ability to use internal restricted access files to execute code and may use data sent over the network, in a manner that is safe from duplication and hacking.

The system of FIG. 7 allows making secure transactions between server 750 and media device 702 for exchanging files; sending updates to media device; updating data on media device etc. Server may send encrypted messages to media device that are encrypted with media device decrypting keys for example. An example usage of this method is sending data files to media device, sending code files to media device, sending policy rules for file usage, updating values such as current balance for electronic money usage, etc.

In some embodiments a module for determining the date and time is added to the media device in order to be able to enforce software policies that are time dependent. One example for such a module is a battery powered clock.

In some embodiments hash values for restricted files are kept and a hash algorithm may be computed internally to media device, in order to verify that files have not been altered. In some embodiments, a certificate is sent with each restricted file, which includes for example a hash value, decryption key and policy of usage for the restricted file. Policy of usage may be for example an expiration date for the usage of the restricted file. Certificate may be encrypted using media device internal key.

It may be appreciated by those skilled in the art of the present embodiments that the present embodiments have the following advantages over existing art:
(a) The present invention provides a method to dynamically receive software and content files and to protect these files from being duplicated and used in an unauthorized manner. Only users with a media device, which includes the protected files, can fully use the software and/or data content.
(b) The present invention allows software owners to let software users fully test their software without risk of duplicating the software. In addition, software owners may extend trial periods for software and/or charge for longer trial periods. In this manner, both software users and software owners gain. Software users can fully try out the software as well as lease the software for a longer period of time, while software owners get paid for their software usage.
(c) Following receipt of software (whether by purchase from a software store or by downloading through the network from an authorized software distributor), there is no need to be connected to the network to be able to use the software.
(d) One single computer (generally digital appliance) of the software user's choice may execute the software at any one time. Since the restricted software files exist on media device, if that media device is placed on another computer, only that computer can fully execute the software. This allows lending the software to other people, or for the software purchaser to move between computers. At any single moment, only one instance of the software may be executed. That instance is the computer that the media device is connected to.
(e) The present invention along with a mechanism such as in patent A, provides an infrastructure to transfer, update, store, control usage and execute software in a manner that is protected and isolated from user reach.
(f) Protected software and data files cannot be altered, leading to a safe and controlled program execution.
(g) A development kit and the infrastructure mentioned above in item (e) above, serve as tools for the development of a new type of applications for the developer community. This type of applications is carried out in a manner that does not allow hacking to take place. This is possible as a result of the ability to protect and control software and software execution environment.

### CONCLUSION, RAMIFICATIONS AND SCOPE

Accordingly, the reader will see that the closure of this invention provides a method to protect software from being duplicated and used in an unauthorized manner. The fact that an internal program interpreter within media device makes use of code files and data files inaccessible by digital appliance, provides the ability to protect software and content files. This protection carried out as follows: Software executing on digital appliance makes requests to a secure program executing within media device. The secure program is an interpreted program executing within media device by internal program interpreter. The secure program completes its computation and sends a reply to the digital appliance software. The fact that the internal program is interpreted allows the flexibility of updating and adding new programs and functionality to media device.

Furthermore the closure of this invention has the additional advantages in that:

(a) Following software installation or purchase, the software may be fully used without the requirement of a network connection.

(b) Software may be freely moved between computers and between people, much like a physical object can be moved between places and people. The software may be used anywhere any time (providing it conforms to the software allowed policy).

(c) The present invention along with patent A for example, provides an infrastructure to transfer, store, control the usage and execute software in a manner that is protected and isolated from user reach.

(d) A development kit and the infrastructure mentioned above in item (c) serve as a tool for the development of new applications, due to the presented ability to protect and control software.

(e) Different software and data files from different vendors may coexist on the same media device without the risk of security breach between files of different companies.

Although the description above contains many specifications, these should not be constructed as limiting the scope of the invention but as merely providing illustrations of some exemplary embodiments of this invention.

For example, there may exist a plurality of files rather than a single described program N′ data and program N′ program code. Some files may be used to read data and some to write data; The interpreter and code that may be used may be a Java virtual machine and java bytecode or even compiled code or semi-compiled code. This invention may be used by applications for different reasons than software protection. Software protection is just one example. Other examples may be game information that may be securely kept and manipulated, data that represents goods or money that may be manipulated etc; A program may be split to other parts than indicated in FIG. 1; Device holding data may be any type of device such as flash cards, hard drives or other devices; The manner of which data is kept inaccessible to users may be done in other manners than that is explained in patent A; Files may be kept encrypted and media device may internally make use of these encrypted file internally. Protected software may be updated into media device as well as protected content files, which may include book files, music files, multimedia files etc. A digital appliance may be a PC as well as other appliances such as-a multimedia player or a mobile phone.

While certain features of the invention have been illustrated and described herein, many modifications, substitutions, changes, and equivalents may now occur to those of ordinary skill in the art. It is, therefore, to be understood that the appended claims are intended to cover all such modifications and changes as fall within the true spirit of the invention.

It is expected that during the life of this patent many relevant secured storage media devices and systems will be developed and the scope of the terms herein, particularly of the terms “autonomous data storage device” and “internal program interpreter”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An autonomous data storage device coupled to an external device, the autonomous data storage device comprising:
a physical file storage;
an internal file management unit capable of accessing said physical file storage and capable of blocking access to at least part of said physical file storage from said external device;
an internal program interpreter unit for executing programs located in said physical file storage;
whereby external software executing in said external device requests said autonomous data storage device to execute protected internal software located in said physical file storage, said protected internal software is at least partially blocked from said external device access by said internal file management unit, said internal program interpreter executes said protected internal software and sends results to said external device for said external software execution in said external device.

2. The device of claim 1, wherein the protected internal software in the physical file storage makes use of a protected internal data content located in said physical file storage, said protected internal data content is at least partially blocked from said external device access by said internal file management unit.

3. The device of claim 1, wherein at least one parameter is passed from said external software to said protected internal software during said external software request to said device to execute said protected internal software.

4. The device of claim 1, further comprising an encryption engine coupled to said internal file management unit capable of decrypting protected files for usage of said internal program interpreter thereby allowing secure distribution of protected files.

5. The device of claim 1, further comprising an encryption engine coupled to said internal file management unit capable of decrypting protected files for usage of said internal program interpreter thereby internal file management is capable of unblocking access to at least part of said physical file storage for said internal program interpreter whereby access to at least part of said physical file storage is blocked for said external device.

6. The device of claim 1 further comprising a secure communication channel between autonomous data storage device and external device.

7. The device of claim 2 wherein internal policy data is kept for said protected internal software and said protected internal data content in said autonomous data storage to allow usage of said protected internal software and said protected internal data content according to said internal policy data.

8. The device of claim 1, wherein hash values are kept for said protected files and an internal execution of a hash algorithm allows checking alteration of protected files.

9. The device of claim 1, wherein internal program interpreter unit is a Java Virtual Machine.

10. A method for executing a digital appliance program in a protected manner using an autonomous data storage device coupled to a digital appliance the method comprising:
a. creating at least one protected program to be executed separately from said digital appliance program,
b. requesting said autonomous data storage device to execute at least one of said protected programs for said digital appliance program,
c. executing at least one of said protected programs by an internal program interpreter located inside said autonomous data storage device,
d. sending calculated results of said execution of at least one protected program to said digital appliance program.

11. A method according to claim 10 wherein said at least one protected program is securely placed on said autonomous data storage device such that digital appliance cannot access at least part of said at least one protected program.

12. A method according to claim 10 wherein said at least one protected program is securely sent to said autonomous data storage device such that digital appliance cannot access at least part of said at least one protected program.

13. A method according to claim 10 wherein said at least one protected program makes use of at least one protected data content during execution of said protected program.

14. A method according to claim 10 wherein at least one parameter is passed from said digital appliance to said autonomous data storage device during said request to said autonomous data storage device to execute said at least one protected program.

15. A method according to claim 10 wherein said creation of protected program is made so that said digital appliance program is missing functionality included in said protected program, thereby creating a dependency between said digital appliance program and said protected program.

16. A method for preparing and distributing protected programs to be executed on a storage device in conjunction with digital appliance programs running on a digital appliance, the method comprising:
a. creating at least one said protected program to be executed in conjunction as part of said digital appliance program,
b. forming license information for said at least one protected program for at least one requesting storage device,
c. distributing said at least one protected program and said license information securely to said requesting at least one storage device.

17. The method of claim 16 wherein development and testing of said protected programs is carried out using a software development kit.

18. The method of claim 16 wherein creation of said digital appliance programs and distribution of said digital appliance programs is carried out.

19. The method of claim 16 wherein said distribution of protected programs to storage devices occurs in an encrypted form.

20. The method of claim 16 wherein said digital appliance program and said protected program are made so that said digital appliance program is missing functionality included in said protected program, thereby creating a dependency between said digital appliance program and said protected program.
